(19) United States
(12) Patent Application Publication
(10) Pub. No.: US 2021/0108658 A1
(43) Pub. Date: Apr. 15, 2021

(54) Fluid Medium Enhancement Apparatus

(71) Applicants: Stephen Heye, Escondido, CA (US); Bruce Heye, Escondido, CA (US); Edward F. Hanson, Escondido, CA (US)

(72) Inventors: Stephen Heye, Escondido, CA (US); Bruce Heye, Escondido, CA (US); Edward F. Hanson, Escondido, CA (US)

(21) Appl. No.: 16/598,553

(22) Filed: Oct. 10, 2019

(51) Int. Cl. F15D 1/04; F16L 43/00

(52) U.S. Cl. CPC F15D 1/04; F16L 43/00

(57) ABSTRACT

A fluid medium flow apparatus for use in a conduit defining a primary channel through which a fluid medium flows includes a vent portion that includes a continuous outer wall situated in the conduit and having a tubular configuration defining an interior area, the vent portion defining an inlet and an outlet downstream of the inlet and includes a radius bend between the inlet and the outlet. A vane is mounted in the interior area intermediate opposed inner surfaces of the continuous side wall and having a length extending between a start of the radius bend and an end of the radius bend and includes a width equal to an inner diameter of the continuous outer wall. The vane dissects the primary channel of the conduit into an inner channel and an outer channel such that the fluid medium is bifurcated into an inner fluid portion and an outer fluid portion.

### BACKGROUND OF THE INVENTION

This invention relates generally to air ducts and, more particularly, to fluid medium enhancement apparatus having an internal vane that operates to avoid turbulence caused by a pressure gradient generated as fluid flows through a bend in a fluid exhaust tube.

It has been found that any fluid medium (e.g. oil, gas, water, air) sent through a tube that has a sharp bend will form eddy currents that introduce turbulence, inefficient flow, and loss of maximum output. Specifically, fluid flowing through a bend in a tube experiences a decrease in pressure on the inside of the bend and eddy currents on the backside of the bend. The eddy currents on the backside of the bend may be generalized as turbulence causing a disruption of flow.

This problem of a sharp bend causing eddy current turbulence may be overcome by positioning a vane that essentially dissects or bifurcates the tube into two channels. Therefore, it would be desirable to have a fluid medium flow apparatus having a vane positioned only in the proximity of a bend and results in minimal loss of pressure compared to a tube not having a vane. Further, it would be desirable to have a fluid medium flow apparatus in which bifurcating a tube with the vane actually increases a velocity of fluid flow on the backside (i.e. downstream) of the bend.

### SUMMARY OF THE INVENTION

A fluid medium flow apparatus for use in a conduit defining a primary channel through which a fluid medium flows according to the present invention includes a vent portion that includes a continuous outer wall situated in the conduit and having a tubular configuration defining an interior area, the vent portion defining an inlet and an outlet downstream of the inlet and includes a radius bend between the inlet and the outlet. A vane is mounted in the interior area intermediate opposed inner surfaces of the continuous side wall and having a length extending between a start of the radius bend and an end of the radius bend and includes a width equal to an inner diameter of the continuous outer wall. The vane dissects the primary channel of the conduit into an inner channel and an outer channel such that the fluid medium is bifurcated into an inner fluid portion and an outer fluid portion.

Therefore, a general object of this invention is to provide a fluid medium flow apparatus having a vane positioned only in the proximity of a bend and results in minimal loss of pressure compared to a tube not having a vane.

Another object of this invention is to provide a fluid medium flow apparatus, as aforesaid, which dissects a tube with the vane and actually increases a velocity of fluid flow on the backside (i.e. downstream) of the bend.

Still another object of this invention is to provide a fluid medium flow apparatus, as aforesaid, which includes a vane that maximizes the efficiency of the flow of a fluid medium through a sharp bend of a fluid conduit.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a fluid medium flow apparatus according to a preferred embodiment of the present invention, illustrated as an integrated bent tube;

FIG. 2 is another perspective view of the fluid medium flow apparatus as in FIG. 1, illustrated as a graduated bent tube;

FIG. 3 is a sectional view taken along line 3-3 of FIG. 1; and

FIG. 4 is a sectional view taken along line 4-4 of FIG. 2.

### DESCRIPTION OF THE PREFERRED EMBODIMENT

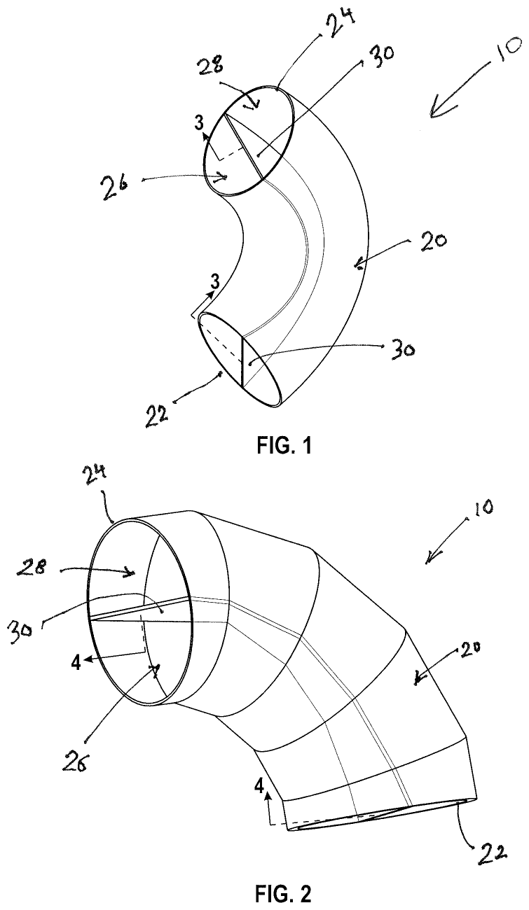

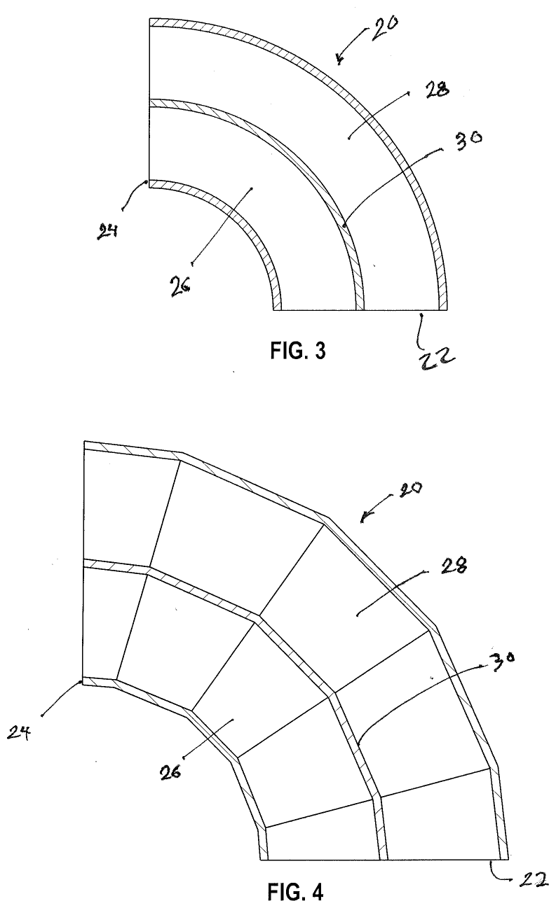

A fluid medium flow apparatus according to a preferred embodiment of the present invention will now be described with reference to FIGS. 1 to 4 of the accompanying drawings. The fluid flow referred to herein includes air, water, oil, gas, or essentially any fluid that flows through a pipe or tube.

A fluid medium flow apparatus 10 includes a vent portion 20 having a generally L-shaped tubular configuration. In other words, the vent portion 20 may have a cylindrical configuration having an equal interior diameter between opposed side surfaces of a continuous outer wall and between respective ends. More particularly, the vent portion 20 is a sleeve constructed of a generally inflexible material, such as hard plastic or metal outer wall (FIG. 1), although the vent portion 20 may include a plurality of individual vent sections adjustably coupled together and capable of being shaped into a final configuration by a user (FIG. 2). In an embodiment, the vent portion 20 may include a plurality of individual vent sections may be fitted together in a friction fit relationship or with fasteners such as pins, hinges, or the like (FIG. 2). Alternatively, the vent portion 20 may be referred to as a flexible sleeve that may be constructed of a flexible material such as clear polyurethane, EPDM, pure gum rubber, rubber coated nylon, silicone, or neoprene (FIG. 1).

The vent portion 20 includes a first end 22 having an open configuration and a second end 24 opposite the first end 22 also having an open configuration. The first end 22 may be referred to as an inlet and the second end 24 may be referred to as an outlet. As indicated above, the vent portion 20 described herein is with specific reference to that portion of a larger exhaust or fluid tube or conduit having a sharp bend or L-shaped configuration.

Examples of vent portions applicable to the present invention may include, but are not limited to, dryer vent exhaust tubes, HVAC ducting, automobile exhaust systems, automotive air intake systems, hydraulic lines, chemical and water lines, oil and water pipelines, and the like. In essence, any motor, appliance, engine, or the like that forces heated or cooled fluid through a hose or tube having a sharp bend may be used with the fluid medium flow apparatus 10.

With reference to the interior of the vent portion 20, the vent portion 20 may include a continuous outer wall that defines an interior area in the form of a channel through which a fluid may flow. In a critical aspect, the fluid medium flow apparatus 10 includes an intermediate wall which will be referred to as a vane 30 that is positioned to extend between the first end 22 and second end 24 of the vent portion 20. Further, the vane 30 may extend along an imaginary centerline axis running through the channel and having a width equal to an inner diameter of the continuous outer wall such that the vane 30 divides or dissects the interior area into a inside section 26 (i.e. an inner channel) and an outside section 28 (i.e. an outer channel). Similarly, the fluid medium flowing through the inside section 26 will be referred to an inner fluid flow and the fluid medium flowing through the outside section 28 will be referred to as an outer fluid flow.

Considering the position of the vane 30 in terms of geometry, the vane 30 that dissects a radius bend is positioned to begin at the very first tangent upstream of the bend and to end at the tangent downstream from the bend. In other words, the vane 30 is positioned at the very start of the bend/curve and extends to the end of the bend/curve. Stated still another way, the vane 30 is positioned to dissect only the curved section of a conduit and not the linear portions on either side of the bend. This positioning is critical to having the following effects on fluid flow. First, with the vane 30 in place as described above, the fluid medium utilizes substantially all of the geometric area of the tube (i.e. the vent portion 20) with minimal loss of pressure. Second, dissecting the vent portion 20 with the vane 30 actually increases the overall velocity of the fluid flow. Since the outside section 28 of the radius bend is longer than the inside section 26, the pressurized fluid flow travels faster through the inside section 26 that it does through the outside section 28. The bifurcated fluid medium may also be referred to as an inner fluid flow and an outer fluid flow. When the portion of the fluid medium enters back into the straight and fully open channel (i.e. where there is no vane), the faster velocity portion of the fluid medium has a scavenging or drafting effect on slower velocity portion of the fluid medium exiting the outside section 28 so as to yield a higher flow rate overall. It is understood that the scavenging or drafting effect refers to an expelling or pulling effect.

Accordingly air may flow through the sub-channels between the inlet and outlet ends and, thus, avoid the turbulence of a fluid flowing through a vent tube not having a vane 30.

It is understood that while certain forms of this invention have been illustrated and described, it is not limited thereto except insofar as such limitations are included in the following claims and allowable functional equivalents thereof.

1. A fluid medium flow apparatus for use in a conduit defining a primary channel through which a fluid medium flows, said fluid medium flow apparatus comprising:
a vent portion that includes a continuous outer wall situated in the conduit and having a tubular configuration defining an interior area, said vent portion defining an inlet and an outlet downstream of said inlet and includes a radius bend between said inlet and said outlet; and
a vane mounted in said interior area and having a length extending between a first tangent of the radius bend and a last tangent of the radius bend and includes a width equal to an inner diameter of said continuous outer wall.

2. The fluid medium flow apparatus as in claim 1, wherein said vane is an intermediate wall having a planar configuration extending linearly along an imaginary center axis defined by said continuous outer wall of said vent portion.

3. The fluid medium flow apparatus as in claim 2, wherein said vane dissects the primary channel of the conduit into an inner channel and an outer channel such that the fluid medium is bifurcated into an inner fluid portion and an outer fluid portion.

4. The fluid medium flow apparatus as in claim 3, wherein:
said inner channel has a linear fluid path that is shorter than a linear fluid path of said outer channel;
said inner fluid portion flows at a velocity greater than a velocity of said outer fluid portion.

5. A fluid medium flow apparatus for use in a conduit defining a primary channel through which a fluid medium flows, said fluid medium flow apparatus comprising:
a vent portion that includes a continuous outer wall situated in the conduit and having a tubular configuration defining an interior area, said vent portion defining an inlet and an outlet downstream of said inlet and includes a radius bend between said inlet and said outlet; and
a vane mounted in said interior area intermediate opposed inner surfaces of said continuous side wall and having a length extending between a start of the radius bend an end of the radius bend and includes a width equal to an inner diameter of said continuous outer wall.

6. The fluid medium flow apparatus as in claim 5, wherein said vane has a planar configuration extending linearly along an imaginary center axis defined by said continuous outer wall of said vent portion.

7. The fluid medium flow apparatus as in claim 6, wherein said vane dissects the primary channel of the conduit into an inner channel and an outer channel such that the fluid medium is bifurcated into an inner fluid portion and an outer fluid portion.

8. The fluid medium flow apparatus as in claim 7, wherein:
said inner channel has a linear fluid path that is shorter than a linear fluid path of said outer channel;
said inner fluid portion flows at a velocity greater than a velocity of said outer fluid portion.

9. The fluid medium flow apparatus as in claim 1, wherein said continuous side wall includes a plurality of tube sections that are each frictionally adjustable relative to one another.

10. A fluid medium flow apparatus for use in a conduit defining a primary channel through which a fluid medium flows, said fluid medium flow apparatus comprising:
a vent portion that includes a continuous outer wall situated in the conduit and having a tubular configuration defining an interior area, said vent portion defining an inlet and an outlet downstream of said inlet and includes a radius bend between said inlet and said outlet; and
a vane mounted in said interior area intermediate opposed inner surfaces of said continuous side wall and having a length extending between a start of the radius bend an end of the radius bend and includes a width equal to an inner diameter of said continuous outer wall;
wherein said vane has a planar configuration extending linearly along an imaginary center axis defined by said continuous outer wall of said vent portion;
wherein said vane dissects the primary channel of the conduit into an inner channel and an outer channel such that the fluid medium is bifurcated into an inner fluid portion and an outer fluid portion;
wherein:
said inner channel has a linear fluid path that is shorter than a linear fluid path of said outer channel;
said inner fluid portion flows at a velocity greater than a velocity of said outer fluid portion.

11. The fluid medium flow apparatus as in claim 10, wherein said continuous side wall includes a plurality of tube sections that are each frictionally adjustable relative to one another.
